(19) United States
(12) Patent Application Publication
(10) Pub. No.: US 2011/0069141 A1
(43) Pub. Date: Mar. 24, 2011

(54) Communication Between Scheduled And In Progress Event Attendees

(76) Inventors: April S. Mitchell, San Jose, CA (US); Ted Beers, Corvallis, OR (US); Kenton O'Hara, Bristol (GB); Jon A. Brewster, Corvallis, OR (US); Lonnie D. Mandigo, Corvallis, OR (US); Michael D. Derocher, Corvallis, OR (US); Diane R. Hammerstad, Corvallis, OR (US)

(21) Appl. No.: 12/936,183

(22) PCT Filed: Apr. 30, 2008
(86) PCT No.: PCT/US08/62067

§ 371 Date: Dec. 7, 2010

(51) Int. Cl. H04N 7/14; G06F 15/16

(52) U.S. Cl. 348/14.09; 709/204; 348/E07.084

(57) ABSTRACT

An event management system is configured to receive a first communication from a person associated with a scheduled event and provide a second communication associated with the first communication to at least one endpoint of an in progress event.

### BACKGROUND

Collaboration event systems allow for collaboration between people in different locations. These systems allow participants to interact with one another through the use of audio and video equipment that provides real time audio and video communications. The process of connecting people across various locations may become complex, particularly where different groups of people desire to use part of the same collaboration event system for different collaboration events.

Participants of an event that is scheduled to begin may arrive at a particular video conference room to find that the room is occupied by participants of an in progress event. At some point, the scheduled event participants may physically knock on the door of the video conference room and verbally notify the in-progress event participants in the room of the overlap. This action may cause confusion with other participants of the in progress event that are in remote video conference rooms. The in-progress event participants in remote rooms may not understand why or how the in-progress event is being interrupted.

### BRIEF DESCRIPTION OF THE DRAWINGS

FIG. 1 is a block diagrams illustrating one embodiment of a collaboration event system.

FIGS. 2A-2B are block diagrams illustrating embodiments of an event endpoint.

FIGS. 3A-3B are block diagrams illustrating embodiments of configurations of audio/video devices.

FIGS. 4A-4B are flow charts illustrating embodiments of methods performed by an event management system.

FIGS. 5A-5C are block diagrams illustrating embodiments of communicating with a person associated with a scheduled event.

FIG. 6 is a block diagram illustrating one embodiment of events managed by an event management system.

FIG. 7 is a block diagram illustrating one embodiment of communications provided to events managed by an event management system.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, an event management system manages collaboration events such as video teleconferences. The event management system maintains registered event specifications for each collaboration event and dynamic event context information that describes the status of collaboration events relative to each other. The event management system uses the registered event specifications and the dynamic event context information to optimize the interaction between collaboration events. The event management system also includes event endpoint information and policies that describe relationships among endpoints and rules associated with endpoints and event attendees.

The event management system provides a person associated with a scheduled event with the ability to simultaneously communicate with one or more endpoints of an in progress event. The event management system associates the person with the scheduled event using the registered event specification for the scheduled event and/or event endpoint information that associates the location of the person with the scheduled event or the in progress event. Using the association and event policies, the event management system causes appropriate communications to be exchanged between the person and all or a subset of endpoints of the in progress event.

In one embodiment described in additional detail below, the event management system provides a person that is checked in for a scheduled event with the ability to select a virtual “knock” function. By selecting the virtual knock function, the person causes a communication to be sent from the event management system to at least two event endpoints of an in progress event simultaneously. The communication notifies the attendees of the in progress event of a resource overlap between the in progress and scheduled events. As a result, all attendees of the in progress event become aware of the resource overlap simultaneously and can collectively decide how to proceed with their event.

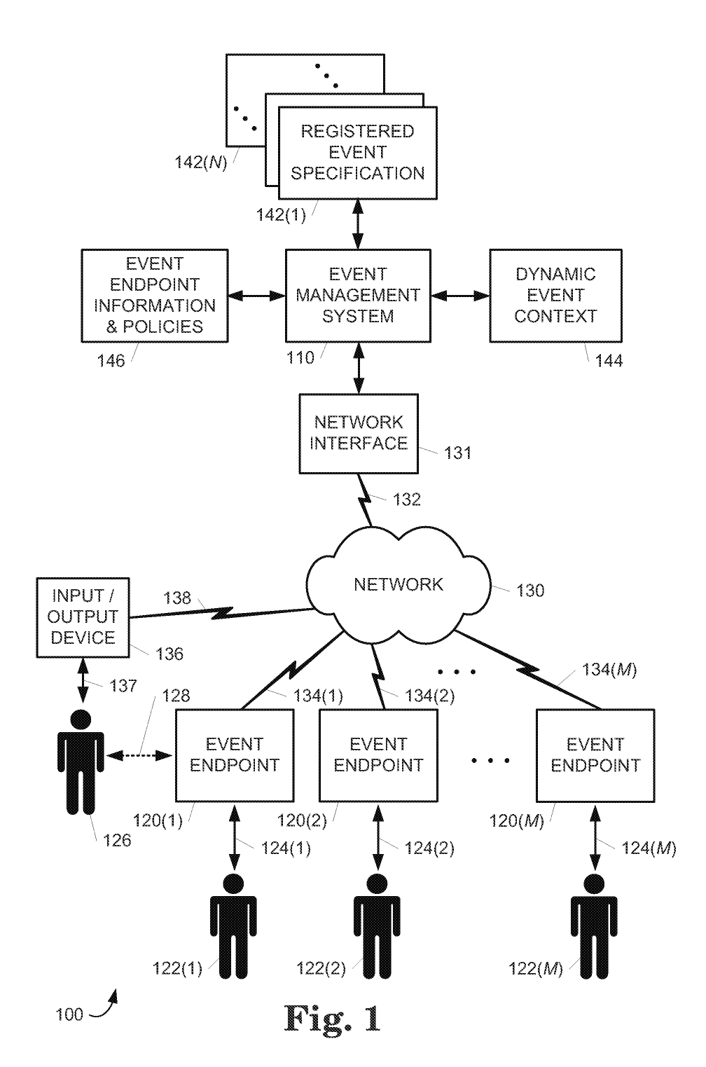

FIG. 1 is a block diagrams illustrating one embodiment of a collaboration event system 100. Collaboration event system 100 includes an event management system 110, a set of event endpoints 120(1)-120(M), and a network 130 that interconnects event management system 110 and event endpoints 120.

Collaboration event system 100 is configured to create and host collaboration events. A collaboration event is an activity with experiential relevance to people, possessing an extension in time and location. Examples of a collaboration event (hereafter “event”) include telepresence videoconferences and meetings conducted using collaboration studio such as a “Halo studio” offered by Hewlett-Packard Co. For each event, collaboration event system 100 exchanges a selected set of A/V media streams 124(1)-124(M) between a selected set or subset of event endpoints 120(1)-120(M).

An event includes a set of collaboration system topologies, each of which include a set or subset of event endpoints 120(1)-120(M). An event also includes a registered event specification 142 that specifies information such as a unique identity token, a purpose, a list of event attendees, a list of event resources, contact information of a host of the event, a priority of the event, start and end dates and times, and/or an event duration. Event resources may include event endpoints 120, physical locations (e.g., a collaboration studio or conference room), input/output devices 136 (e.g., interactive touchpoints), and attendees 122.

The collaborative event may take place in two or more locations (e.g., different cities) that each have an event endpoint 120 to connect a set of one or more attendees 122 or media resources in each of the locations. Cameras and microphones, for example, may capture video and audio from one or more of the locations (i.e., at one endpoint) and the video and audio may be output using one or more display devices and speakers, for example, at one or more other locations (i.e., one or more other endpoints). In addition, various types of pre-recorded A/V data, such as content from a DVD, may be transported to one or more of the locations where it may be output using a display device or speakers, for example. One or more locations of the collaborative event may include arrangements of office furniture (e.g., office chairs and a conference table) and A/V gear to provide persons with gaze awareness and a full immersion feeling.

Event management system 110 is configured to initiate, execute, host, and optimize collaboration events using registered event specifications 142(1)-142(N), dynamic event context 144, and event endpoint information and policies 146. Each event is registered with event management system 110, either in advance (i.e., scheduled ahead of time) or in real time (i.e., scheduled on an ad hoc basis), to create a registered event specification 142 for the event using any suitable device for accessing event management system 110 (e.g., an event endpoint 120 or an input/output device 136). Event management system 110 may reference and use each registered event specification 142 for various purposes including preparation for and execution of an event in accordance with the information in a registered event specification 142.

Dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations) for each event. Event management system 110 generates and maintains dynamic event context 144 to monitor and manage the real-time system status of collaboration event system 100.

Endpoint information and policies 146 describes the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events.

Each event endpoint 120(1)-120(M) provides a respective set of one or more attendees 122(1)-122(M) with a respective set of one or more audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

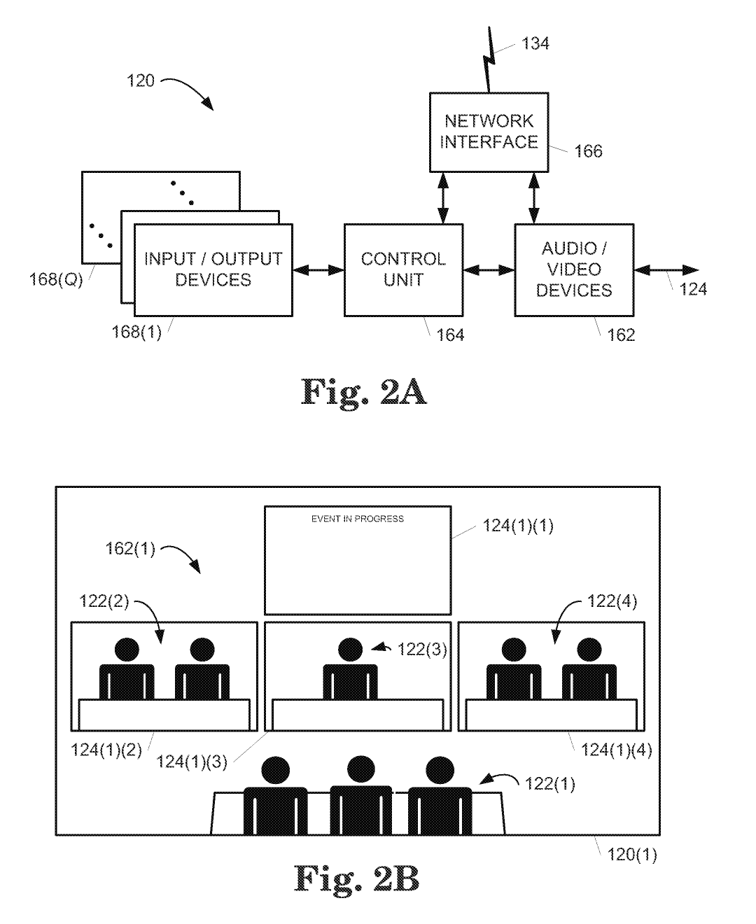

FIGS. 2A-2B are block diagrams illustrating embodiments of event endpoint 120. In the embodiment of FIG. 2A, event endpoint 120 includes a set of one or more audio and/or video (A/V) devices 162, a control unit 164, a network interface 166 and a set of one or more input/output (I/O) devices 168(1)-168(Q).

A/V devices 162 includes any type, number, and combination of audio and/or video input and/or output devices. Examples of A/V input devices include microphones, still and video cameras, media players, and computer and storage systems. The A/V input devices capture, detect, receive or otherwise input live or pre-recorded media streams 124 and provide the input media streams 124 to control unit 164 and/or network interface 166. Examples of A/V output devices include speakers, headphones, headsets, media recorders, and display devices such as projectors, computer monitors, and televisions. The A/V output devices receive media streams from control unit 164 and/or network interface 166 and provide, display, play, or otherwise output live or pre-recorded media streams 124.

Control unit 164 manages the operation of event endpoint 120 by providing control signals and/or other information to and receiving control signals and/or other information from A/V devices 162, network interface 166 and input/output devices 168(1)-168(Q). In some embodiments, control unit 164 may perform processing on media streams received from A/V devices 162 and/or network interface 166 prior to the media streams being provided to network interface 166 or output by A/V devices 162. The processing may include coding or decoding media streams from one media and/or network format to another media and/or network format.

Network interface 166 includes any suitable type, number, and/or combination of network devices that allow event endpoint 120 to communicate with network 130 using network connection 134. Network interface 166 receives media streams across network connection 134 and provides the media streams to control unit 164 and/or A/V devices 162. Network interface 166 also receives media streams from control unit 164 and/or A/V devices 162 and provides the media streams to network 130 using network connection 134.

I/O devices 168(1)-168(Q) include any suitable type, number, and/or combination of input and/or output devices that allow attendees 122, administrators, or other persons to communicate with event endpoint 120. The communications may cause event endpoint 120 and/or collaboration event system 100 to perform functions indicated by attendees 122, administrators, or other persons. Examples of I/O devices 168 include interactive touchpoints, display screens, keyboards, and selection or navigation devices (e.g., a mouse, joystick, flywheel, or touchpad).

In other embodiments, the functionality of an A/V device 162 and an I/O device 168 may be included in a single unit such as a laptop computer. In addition, other embodiments may include A/V devices 162 but omit I/O devices 168 or may include I/O devices 168 but omit A/V devices 162.

FIG. 2B illustrates an embodiment of the operation of endpoint 120(1). Endpoint 120(1) provides attendees 122(1) who are present at endpoint 120(1) with media streams 124(1)(1)-124(1)(4) using any suitable type and/or combination of audio/video devices 162(1). Audio/video devices 162(1) are configured to allow for gaze awareness and a full immersion feeling for attendees 120(1).

In the example of FIG. 2B, media stream 124(1)(1) provides information about the event attended by attendees 122(1) (e.g., status information, notifications, configuration options, etc.) and media streams 124(1)(2)-124(1)(4) provide audio and video representations of by attendees 122(2)-122(4), respectively, who are present at event endpoints 120(2)-120(4), respectively. Attendees 122(1)-122(4) collectively represent the set of attendees who are present for the event illustrated by the example of FIG. 2B. In other embodiments, endpoint 120(1) may provide other numbers of media streams 124(1) to attendees 120(1) and may have other configurations of audio/video devices 162(1) relative to attendees 120(1).

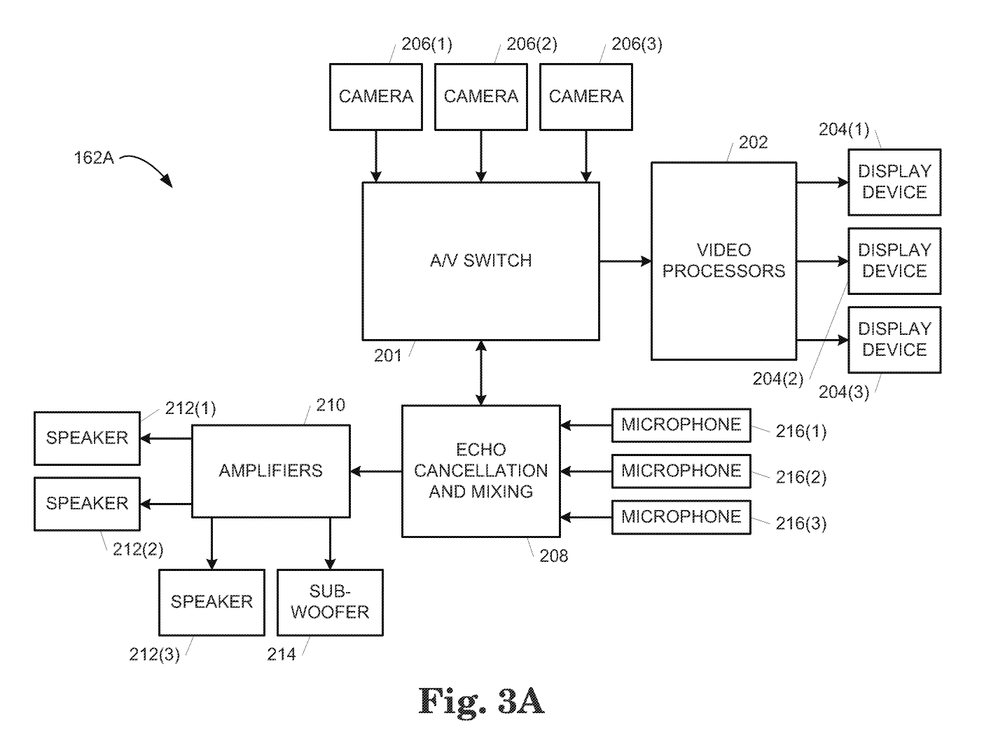

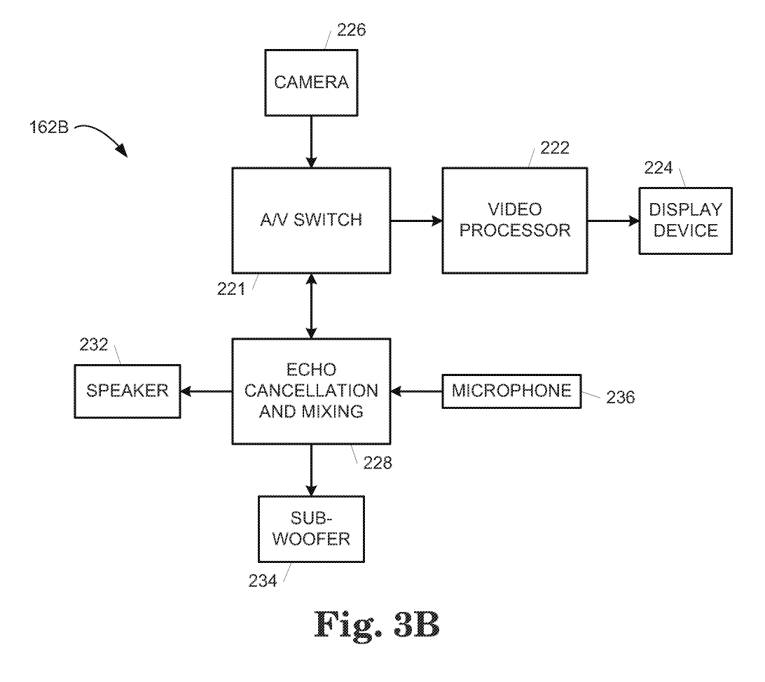

FIGS. 3A-3B are block diagrams illustrating embodiments of configurations of audio/video devices 162.

In one embodiment, A/V devices 162 includes integrated A/V gear that forms a collaboration studio such as a “Halo studio” offered by Hewlett-Packard Co. as shown in the embodiment 162A of FIG. 3A. In the embodiment of FIG. 3A, video processors 202 provide video data from A/V switch 201 to display devices 204(1)-204(3), and display devices 204(1)-204(3) display the video data. Cameras 206(1)-206(3) capture video data and provide the video data to A/V switch 201. An echo cancellation and mixing unit 208 mixes and processes audio data from A/V switch 201 and provides the processed audio data to amplifiers 210. Amplifiers 210 amplify the audio data and provide the audio data to speakers 212(1)-212(3) and sub-woofer 214. Speakers 212(1)-212(3) output the higher frequencies of the audio data, and sub-woofer 214 outputs the lower, bass frequencies of the audio data. Microphones 216(1)-216(3) capture audio data and provide the audio data to A/V switch 201.

Display devices 204(1)-204(3) may be arranged in such a manner around a conference table and chairs to allow for gaze awareness and a full immersion feeling in one embodiment.

In another embodiment, A/V devices 162 includes A/V gear as shown in the embodiment 162B of FIG. 3B. In the embodiment of FIG. 3B, video processor 222 provides video data from A/V switch 221 to display device 224, and display device 224 displays the video data. Camera 226 captures video data and provides the video data to A/V switch 221. An echo cancellation and mixing unit 228 mixes and processes audio data from A/V switch 221 and provides the processed audio data to speaker 232 and sub-woofer 234. Speaker 232 outputs the higher frequencies of the audio data, and sub-woofer 234 outputs the lower, bass frequencies of the audio data. Microphone 236 captures audio data and provides the audio data to A/V switch 221 through echo cancellation and mixing unit 228.

Referring back to FIG. 1, network 130 may be any suitable type of network or combination of networks formed from any suitable number, type, and/or combination of network devices (not shown). The network devices may operate using any suitable network protocol or protocols and may connect to any suitable number of event endpoints 120 or other computer or storage systems. Network 130 may include any suitable combination of a secure networks (e.g., enterprise networks or corporate intranets) with limited and secure connections to other systems or unsecure networks with at least one unsecure connection to another system.

Network 130 may be a local, regional, or global network of any suitable network configuration that ranges from local point-to-point connections between event management system 110 and event endpoints 120 to a global array of connections that interconnect event management system 110 and event endpoints 120. Network 130 may be private or publicly available and include one or more connections to the Internet.

Network 130 may be designed specifically to optimize high bandwidth with low latency to be able to transport live, interactive, audio, video, and other data rich media streams. Network 130 may have a smallest link of 45 Mbps, in one embodiment, to avoid any significant serialization delay. Network 130 may also use a flat network topology to minimize latency. In order to keep a high quality end-user experience, network 130 may keep the total one-way latency between any event endpoints 120 to less than one-quarter of a second. This total latency may encompass all aspects of encoding/decoding, encapsulation/de-encapsulation, capture and presentation, filtering, processing, compression and decompression, image compositing, and transport latencies across the transmission path. As the contribution of each component of network 130 to overall latency decreases (as technology improves), the length of the “reach” of where different sites can be physically located may be increased.

To better preserve the shortest paths capable of reliable delivery with little packet loss, bandwidth and network resource mechanisms (not shown) may be used to insure high-quality sessions for the duration of the collaboration session. As most traffic streams are presumed to take place linking a pair or small number of event endpoints 120 together for any given session, event management system 110 may have little presumption of event pre-emption once authorized events commence. In some embodiments, longer latency and/or loss tolerant sessions may be provided over network 130. Such services may include directory, presence, messaging, credential verification, calibration, and time/name services for examples.

The interior of network 130 may concentrate on speedy delivery of traffic flows. Any access control, encryption/decryption and other proxy services, if needed, may occur at the edge of network 130 such as in event endpoints 120 and not the interior of network 130 in some embodiments. This design may make the core of the backbone of network 130 simpler to grow, maintain, stable, and very fast.

Event management system 110 connects to network 130 using a network interface 131 and a network connection 132, and event endpoints 120(1)-120(M) connect to network 130 using respective network connections 134(1)-134(M). Each network connection 132 and 134(1)-134(M) may include any suitable type, number, and/or combination of wired or wireless network connections. For example, network connections 132 and 134(1)-134(M) may each be a leased line (i.e., a T3, optical, cable, or wireless high speed link) which provides a large data pipe to and from event management system 110, event endpoints 120(1)-120(M), and input/output device 136, respectively.

Input/output (I/O) device 136 may be any suitable type of device (e.g., a portable or non-portable device such as an interactive touchpoint, a computer, a cell phone, a media player, or a personal digital assistant) configured to communicate with event management system 110. I/O device 136 is configured to receive inputs from a person 126 and/or provide outputs to person 126 as indicated by an arrow 137. The outputs may include audio and/or video outputs. I/O device 136 connects to network 130 using any suitable wired or wireless network connection 138. I/O device 136 may be omitted in some embodiments.

In operation, event management system 110 initiates, executes, hosts, and optimizes collaboration events using registered event specifications 142(1)-142(N), dynamic event context 144, and event endpoint information and policies 146.

Event management system 110 initiates execution of an event by allocating resources for creating a real-time representation of the event according to the registered event specification 142 of the event to optimize the experience of attendees 122. The allocated resources include the set or a subset of event endpoints 120 as indicated by the registered event specification 142. Event management system 110 continues execution of the event with changes to the topology of the event (e.g., the addition or removal of event endpoints 120 during the event) to maintain and optimize the experience of attendees 122 and ends as dictated by the registered event specification 142 or by external inputs (e.g., from an attendee 122). During execution, event management system 110 may describe an event as being “in-progress”.

In preparation for event execution (i.e., during event preparation) and during event execution, certain activities may be performed by event resources or event management system 110 that impact the management of the event, such as an attendee 122 checking in at an endpoint location, an input/output device associated with an endpoint, or another location. During the course of the lifecycle of an event, additional related artifacts may be added to the event, such as an archive of the execution of the event.

Event management system 110 optimizes event preparation and event execution for each registered event that requires various resources including those resources whose states may impact event preparation and execution. The optimization accounts for resources that may be in use by one or more in-progress events, resources that may be unavailable (e.g., requested for use by another event or out of service), key event attendees 122 that are missing, and other critical event information. Event management system 110 also optimizes event execution for in-progress events by preventing unwanted disruption of an event using resources required by the registered event and by handling requests for resources made by other events.

Event management system 110 performs the optimization using registered event specifications 142 for all related events including the primary event being prepared and other events in progress that are consuming needed resources and dynamic event context information 144 which includes information about event resources (e.g., resources used by other in-progress events and other status information about needed resources). Event management system 110 may also perform the optimization using information provided by attendees, administrators, and/or other persons via I/O devices 168 and/or 136 associated with the event in progress and the registered events and event endpoint information and policies 146. Event endpoint information and policies 146 includes information about the physical and assigned relationships among resources, including relationship information about event endpoints 120 and I/O devices 168 and/or 136, policies regarding the management of shared resources to facilitate optimal event execution, and principles governing the systems behaviors in consideration of the multitude of registered and dynamic information.

Using inputs from registered event specifications 142, dynamic event context information 144, I/O devices 168 and/or 136, and event endpoint information and policies 146, event management system 110 applies event optimization policies to interact with an in-progress event, with related resources such as endpoints 120, and with related input/output devices 168 and/or 136. In doing so, event management system 110 optimizes the experience of attendees 122 such as by event preparation and creating a plan for execution when an overlap is detected between an in-progress event and a scheduled event.

As used herein, the term overlap refers to a commonality of resources between two or more events that may prevent one or more of the events from proceeding as currently defined by the respective registered event specifications 142 for the one or more events. The commonality may be an event endpoint or endpoints 120, an event attendee 122, an event resource (e.g., A/V equipment), or at least a portion of network 130 or network interfaces and connections 132 or 134, for example, where the commonality is not conducive to being used by two or more events at the same time or close to the same time.

Event management system 110 provides a communication pathway between events using network interface 131 and network connection 132 to allow attendees or other interested persons of one event to interact with attendees or other interested persons of another event. Event management system 110 may use the communication pathway in instances where the events both specify one or more common resources (i.e., overlap) to allow the attendees or other interested parties of the events to negotiate the use of the resources. The communication pathways may extend beyond endpoints 120 to hallways or vestibules outside of or nearby endpoints 120 or other locations remotely located from endpoints 120.

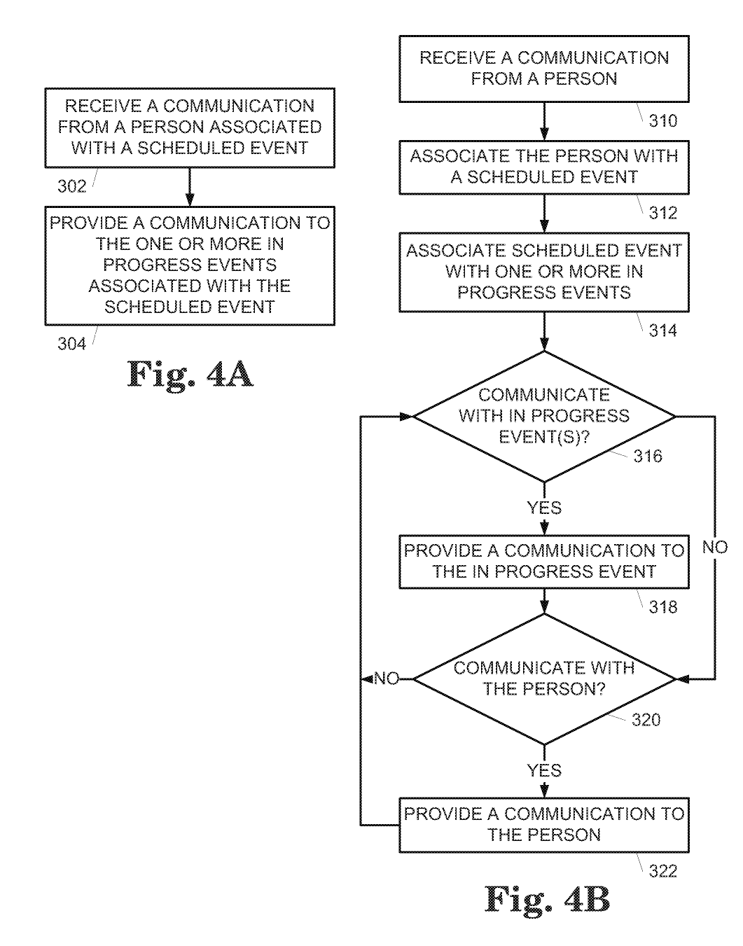

Event management system 110 provides a person 126 associated with a scheduled event with the ability to simultaneously communicate with one or more endpoints 120 of an in progress event as illustrated in embodiments of methods shown in FIGS. 4A and 4B. Event management system 110 causes appropriate communications to be exchanged between person 126 associated with the scheduled event and all or a subset of endpoints 120 of the in progress event.

Referring to the embodiment of FIG. 4A, event management system 110 receives a communication from a person 126 associated with a scheduled event as indicated in a block 302. Event management system 110 identifies the scheduled event using a registered event specification 142 that identifies a plurality of event endpoints 120 that will provide a set of media streams 124 to one or more sets of attendees 122 during the scheduled event.

Person 126 may be associated with the scheduled event in various ways. For example, person 126 may be an organizer or scheduled attendee of the scheduled event who is identified by registered event specification 142 for the scheduled event. Person 126 may also be someone acting on behalf of an organizer or scheduled attendee identified by registered event specification 142 for the scheduled event. Person 126 may further be attempting to register for the scheduled event by adding their name to registered event specification 142 for the scheduled event. In addition, person 126 may be located at or near an event endpoint 120 for the scheduled event.

The communication received from person 126 by event management system 110 may include various types of information. For example, the information may identify person 126 directly or indirectly (e.g., using a name, a event code, or other identifier), may identify a location of person 126, or may specify or request an action to be performed by event management system 110. The communication referred to in block 302 may represent one or more of a set of communications exchanged between person 126 and event management system 110.

Event management system 110 provides a communication to one or more in progress events associated with the scheduled event as indicated in a block 304. Event management system 110 associates one or more in progress events with the scheduled event using registered event specifications 142 for the events, dynamic event context 144, and/or event endpoint information and policies 146. The in progress events include a respective plurality of event endpoints 120 that are currently providing a respective set of media streams 124 to respective sets of attendees 122. Event management system 110 provides the communication to all event endpoints 120 of each in progress event or at least two selected endpoint event endpoints 120 of each in progress event. The event endpoints 120 of an in progress event that receive the communication may be remotely located from one another.

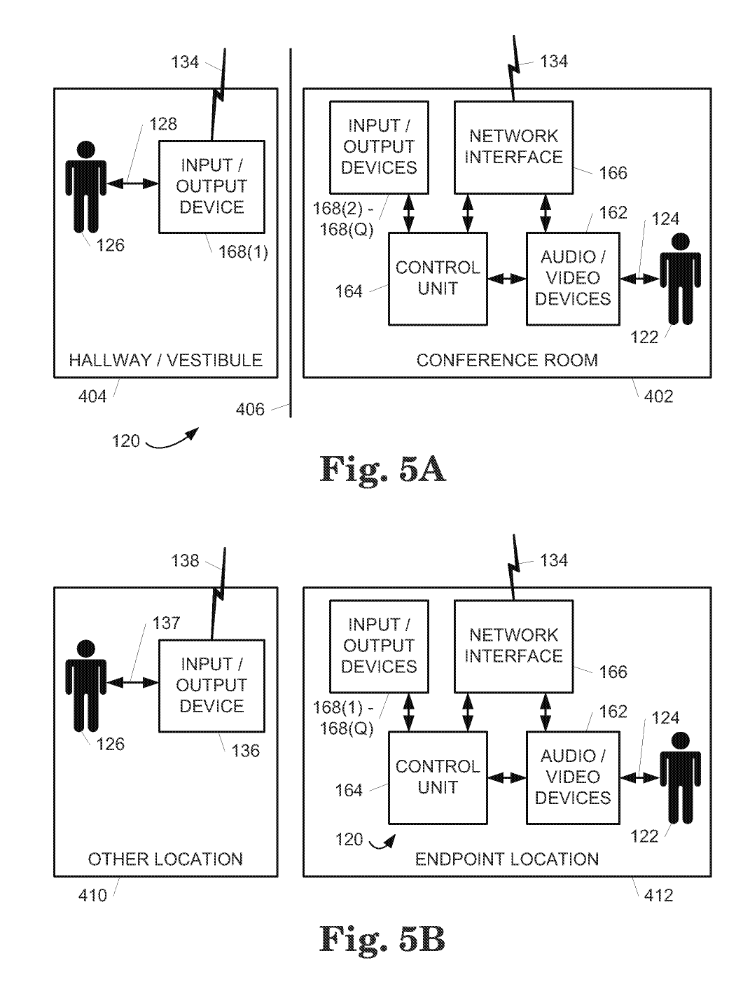

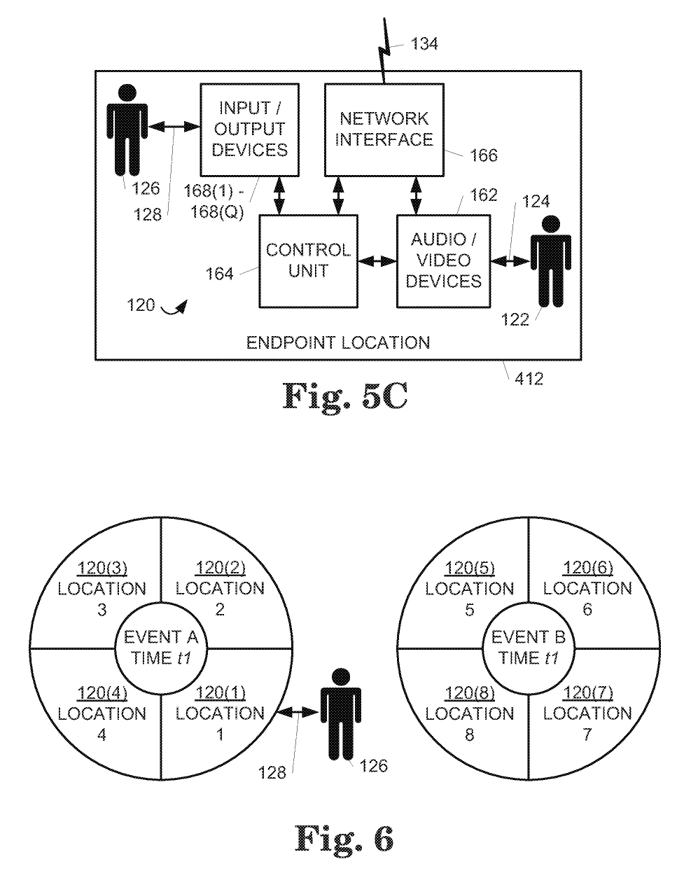

Using the embodiment of FIG. 4A or 4B (described below), person 126 may provide the communication to event management system 110 using an input/output device 168 or 136 from any suitable location. FIGS. 5A-5C are block diagrams illustrating embodiments of communicating with a person 126 who is associated with a scheduled event. FIGS. 5A-5C illustrate at least three possible locations where person 126 may provide the communication to event management system 110.

In the embodiment of FIG. 5A, person 126 accesses an input/output device 168(1) (e.g., an interactive touchpoint or touchpad display) of an event endpoint 120 to communicate with event management system 110. In the embodiment of FIG. 5A, event endpoint 120 includes a conference room 402 and a hallway or vestibule 404 outside of conference room 402 as indicated by a barrier 406. Barrier 406 may be a wall, a door, a corridor, or other suitable physical structure or space that separates conference room 402 from hallway or vestibule 404. Input/output device 168(1) is located in hallway or vestibule 404 adjacent to conference room 402. Input/output device 168(1) is associated with event endpoint 120 with a physical connection (e.g., network connection 134) or other information that specifies the physical arrangement of input/output device 168(1) in event endpoint 120. Accordingly, person 126 may use input/output device 168(1) without visually or audibly interrupting an event taking place in conference room 402. Person 126, however, may opt to use input/output device 168(1), as indicated by arrow 128, in conjunction with event management system 110 to communicate with attendees 122 of an in progress event in conference room 402. Communications to and from the in progress event may be included as part of media streams 124.

Audio/video devices 162 of endpoint 120 that provide media streams 124 to attendees 122 and/or capture media streams 124 from attendees 122 are located inside conference room 402. Input/output device 168(1) is located outside conference room 402. Although other components of endpoint 120 are shown as being inside conference room 402 in the embodiment of FIG. 5A, some or all of these components may be located outside of or adjacent to conference room 402 in other embodiments (e.g., in a control room (not shown)).

In the embodiment of FIG. 5B, person 126 accesses an input/output device 136 (e.g., a mobile device) to communicate with event management system 110. In the embodiment of FIG. 5B, event endpoint 120 resides an endpoint location 412. Person 126 uses input/output device 168(1) from any other location 410 that may be remotely located from or in close proximity to endpoint location 412. Input/output device 136 has no physical relationship with endpoint location 412 or event endpoint 120 in the embodiment of FIG. 5B. Input/output device 136 may form a virtual association with endpoint location 412 or event endpoint 120 through communications with event management system 110. Person 126 may use input/output device 136, as indicated by arrow 137, in conjunction with event management system 110 to communicate with attendees 122 of an in progress event in endpoint location 412. Communications to and from the in progress event may be included as part of media streams 124.

In the embodiment of FIG. 5C, person 126 accesses any of input/output devices 168(1)-168(Q) (e.g., an interactive touchpoint or touchpad display) of event endpoint 120 to communicate with event management system 110. Person 126 may be one of the set of attendees 122 of an event at event endpoint 120. Person 126 uses an input/output device 168, as indicated by arrow 128, in conjunction with event management system 110 to communicate with other attendees 122 of an in progress event at another event endpoint 120 (not shown in FIG. 5C). The endpoint 120 where person 126 is located may be remotely located from or in close proximity to the other endpoint 120. Communications to and from the in progress event may be included as part of media streams 124 at the other event endpoint 120.

In the embodiment of FIG. 4B, event management system 110 receives a communication from person 126 as indicated in a block 310. As with the embodiment of FIG. 4A, the communication may include information that identifies person 126 directly or indirectly (e.g., using a name, a event code, or other identifier), identifies a location of person 126, or specifies or requests an action to be performed by event management system 110.

Event management system 110 associates person 126 with a scheduled event as indicated in a block 312. Event management system 110 associates person 126 with a scheduled event by determining a relationship between person 126 and a scheduled and/or in progress event. The relationship may depend on an identity of person 126 or a location of person 126.

In one embodiment, event management system 110 associates person 126 with a scheduled event by matching information received from person 126 (e.g., a name, an event code, or other identifier) with information in a registered event specification 142 for the scheduled event.

In another embodiment, event management system 110 associates person 126 with a scheduled event by matching location information received from person 126 with location information in a registered event specification 142 for the scheduled event and/or event endpoint information and policies 146. With the embodiment of FIG. 5A, for example, event management system 110 may recognize input/output device 168(1) as the source of a communication from person 126 and determine that person 126 is outside of conference room 402 of event endpoint 120 using event endpoint information and policies 146 which specifies a location of input/output device 168(1). Event management system 110 may further identify a scheduled event that is scheduled to include conference room 402 of event endpoint 120 using a registered event specification 142 for the scheduled event or an in progress event that currently includes conference room 402 of event endpoint 120 using a registered event specification 142 for the in progress event. From these determinations, event management system 110 may associate person 126 with the scheduled event.

After associating person 126 with a scheduled event, event management system 110 associates the scheduled event with one or more in progress events as indicated by a block 314. In one embodiment, event management system 110 identifies an overlap of resources between the scheduled event and one or more in progress events using registered event specifications 142 for the events and/or dynamic event context 144. The overlap of resources provides the basis for associating the scheduled event and the one or more in progress events. In other embodiments, event management system 110 bases the association between the scheduled event and the one or more in progress events on other suitable criteria using registered event specifications 142 for the events, dynamic event context 144, and/or event endpoint information and policies 146.

Event management system 110 determines whether a communication with the one or more in progress events is desired as indicated in a block 316. Event management system processes the communication of block 310 in accordance with policies corresponding to the scheduled and in progress events to make the determination. Event management system 110 may determine that a communication is desired using the communication from person 126, registered event specifications 142, and/or event endpoint information and policies 146.

For example, the communication from person 126 may express a request from person 126 for event management system 110 to notify the in progress events that the scheduled event is waiting on one or more resources of the in progress events. As another example, registered event specification 142 for the scheduled event may indicate that the scheduled event has a higher priority than the in progress events and may cause event management system 110 to provide a communication to the in progress events that indicates that the in progress events are ending. As a further example, event endpoint information and policies 146 may direct event management system 110 to notify the in progress events anytime that a resource overlap that involves the one or more in progress events is detected.

Registered event specifications 142 and/or event endpoint information and policies 146 may also indicate that one or more in progress events are not to be disturbed (i.e., no communications are to be sent during the event). If so, then event management system 110 determines that a communication to the in progress events is not desired.

If event management system 110 determines that a communication is desired, event management system 110 provides a communication to the one or more in progress events as indicated in a block 318. Event management system 110 provides the communication to all event endpoints 120 of each in progress event or at least two selected endpoint event endpoints 120 of each in progress event. Event management system may select the communication of block 318 in accordance with policies corresponding to the scheduled and in progress events as expressed in registered event specifications 142 and/or event endpoint information and policies 146.

Event management system 110 determines whether a communication with person 126 is desired as indicated in a block 320. Event management system 110 may determine that a communication is desired using a response from an in progress event, registered event specifications 142, and/or event endpoint information and policies 146. For example, a response from the in progress event may request additional time to use a common resource and event management system 110 may desire to communicate this request to person 126. As another example, registered event specification 142 for an in progress event may indicate that the in progress event has a higher priority than the scheduled event and may cause event management system 110 to provide a communication to person 126 that indicates that the in progress events will be continuing. As a further example, event endpoint information and policies 146 may direct event management system 110 to notify person 126 of an alternate resource to use for the scheduled event. If event management system 110 determines that a communication is desired, event management system 110 provides a communication to person 126 as indicated in a block 322.

Event management system 110 may repeat the functions of blocks 316, 318, 320, and 322 any suitable number of times to provide a communications pathway between a scheduled event and one or more in progress events. At each step, event management system 110 selects appropriate communications to be provided based on registered event specifications 142, dynamic event context 144, and event endpoint information and policies 146.

In the above embodiments of FIGS. 4A and 4B, event management system 110 may provide person 126 with communications that describe the status of one or more in progress events, communications from attendees 122 of an in progress event, or functions that allow person 126 to simultaneously communicate with one or more endpoints 120 of an in progress event. The communications may occur in response to person 126 checking in for the scheduled event.

Once any resource overlap with the scheduled event is resolved, event management system 110 allocates the set of event endpoints 120 and any other resources to the scheduled event to initiate the event.

In one embodiment, event management system 110 provides a person 126 that is checked in for a scheduled event with the ability to select a virtual “knock” function. By selecting the virtual knock function, person 126 causes a communication to be sent from event management system 110 to at least two event endpoints 120 of an in progress event simultaneously. The communication notifies the attendees of the in progress event of a resource overlap between the in progress and scheduled events. As a result, all attendees of the in progress event become aware of the resource overlap simultaneously and can collectively decide how to proceed with their event.

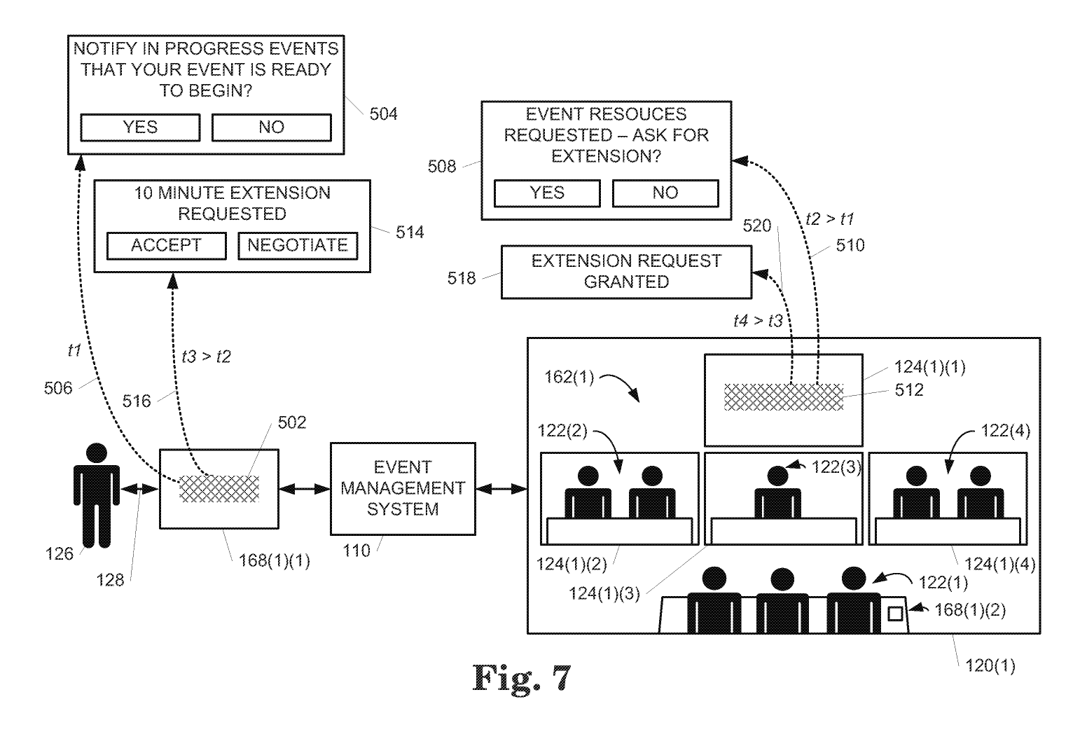

An example of the use of the communication pathway provided by event management system 110 between events will now be described with reference to FIGS. 6 and 7. FIG. 6 is a block diagram illustrating one embodiment of in progress events A and B managed by event management system 110 at time t1. FIG. 7 is a block diagram illustrating one embodiment of communications provided to events A and B by an event management system 110.

As shown in FIG. 6, in progress event A includes event endpoints 120(1)-120(4) at locations 1-4, respectively, at time t1. Event B includes event endpoints 120(5)-120(8) at locations 5-8, respectively, at time t1. A scheduled event is set to begin at or around time t1 and is scheduled, per a registered event specification 142, to include at least event endpoints 120(1), 120(5), and 120(6).

A scheduled event attendee, i.e., person 126, arrives at a vestibule (e.g., vestibule 404 as shown in FIG. 5A) of endpoint 120(1) at or around time t1. Person 126 checks in for the scheduled event and begins communicating with event management system 110 using an input/output device 168(1)(1) in the vestibule of event endpoint 120(1) as indicated by arrow 128. As shown in FIG. 7, event management system 110 provides communications to person 126 that are displayed in a display area 502 of input/output device 168(1)(1). Person 126 inputs information into input/output device 168(1)(1) which causes communications to be provided to event management system 110.

In the example of FIG. 7, event management system 110 provides a communication 504 to person 126 (and possibly other checked in scheduled event attendees 122 at other locations) asking whether person 126 would like to notify in progress events A and B that the scheduled event for person 120 is ready to begin. Input/output device 168(1)(1) displays communication 504 in display area 502 at or around time t1 as indicated by an arrow 506. In response to communication 504, person 126 may select the “YES” option to cause event management system 110 to provide a communication 508 to in progress events A and B.

Event management system 110 provides communication 508 to all endpoints 120(1)-120(8) of in progress events A and B. Event A is shown in FIG. 7 from the viewpoint of event endpoint 120(1) and includes sets of attendees 122(1)-122(4) at event endpoints 120(1)-120(4), respectively. Media streams 124(1)(2)-124(1)(4) depict sets of attendees 122(2)-122(4) at event endpoints 120(2)-120(4), respectively, using the set of audio/video devices 162(1) at event endpoint 120(1). An media stream 124(1)(1) includes communications from event management system 110 which are displayed in a display area 512 by an audio/video device 162(1). Media streams 124 in the remaining event endpoints 120(2)-120(8) also display the communications from event management system 110 simultaneously with the display of the communications by event endpoint 120(1).

The audio/video device 162(1) of event endpoint 120(1) displays communication 508 at a time t2 that is subsequent to time t1 as indicated by an arrow 510. Communication 508 indicates that the use event resources of in progress events A and B are being requested by a scheduled event and provides an option to in progress events A and B to ask the scheduled event for an extension of time. In response to communication 508, sets of attendees 122(1)-122(4) of event A may confer and collectively decide how to respond. Similarly, sets of attendees 122(5)-122(8) of event B may confer and collectively decide how to respond separately from the deliberations of event A. In the example of FIG. 7, an attendee 122(1) uses an input/output device 168(1)(2) of event endpoint 120(1) to select the “YES” option and cause event management system 110 to provide a communication 514 to one or more scheduled event attendees (e.g., person 126).

Communication 514 indicates that in progress events A and B have requested a 10 minute extension of time and provides an option to person 126 to accept the request or negotiate the request. Input/output device 168(1)(1) displays communication 514 in display area 502 at a time t3 that is subsequent to time t2 as indicated by an arrow 516. In response to communication 514, person 126 may select the “ACCEPT” option to cause event management system 110 to provide a communication 518 to in progress event A.

In progress event B attendees 122(5)-122(8) may also provide a response (not shown) to communication 508 that selects the “NO” option and effectively choose to end event B. Attendees 122 of the scheduled event may then occupy event endpoints 120(5) and 120(6) in preparation for the scheduled event.

Communication 518 indicates that the extension of time request has been granted by the scheduled event. The audio/video device 162(1) of event endpoint 120(1) displays communication 518 at a time t4 that is subsequent to time t3 as indicated by an arrow 520. Subsequent to the 10 minute extension, sets of attendees 120(1)-120(4) may end event A and vacate event endpoints 120(1)-120(4). Attendees 122 of the scheduled event, including person 126, may then occupy event endpoint 120(1) to allow the scheduled event to begin between at least event endpoints 120(1), 120(5), and 120(6).

In the above embodiments, event management system 110 may include any suitable combination of hardware and software components. In one embodiment, event management system 110 includes one or more programs that is stored in any suitable type, number, and/or combination of portable or non-portable storage media (not shown) within or otherwise accessible to event management system 110. The programs are accessible to and executable by any suitable type, number, and/or combination of processors (not shown) in event management system 110 to perform the functions described above.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited by the claims and the equivalents thereof.

What is claimed is:

1. A method performed by an event management system, the method comprising:
receiving a first communication from a person associated with a first event scheduled to include a first plurality of event endpoints that provide a first set of media streams to a first set of attendees; and
providing a second communication associated with the first communication to at least one of a second plurality endpoints of a second event in progress, the second plurality of event endpoints providing a second set of media streams to a second set of attendees.

2. The method of claim 1 further comprising:
providing the second communication associated with the first communication to at least two of the second plurality endpoints of the second event.

3. The method of claim 1 further comprising:
receiving the first communication from an input/output device that is associated with one of the first plurality of event endpoints;
wherein the one of the first plurality of event endpoints overlaps with one of the second plurality of event endpoints, and wherein the input/output device is located outside of a room that includes a set of audio/video devices of the one of the first plurality of event endpoints.

4. The method of claim 1 further comprising:
receiving the first communication from an input/output device that is associated with one of the first set of attendees.

5. The method of claim 1 further comprising:
receiving the first communication from a first one of the first plurality of event endpoints;
wherein a second one of the first plurality of event endpoints overlaps with one of the second plurality of event endpoints.

6. The method of claim 1 further comprising:
receiving a third communication from one of the second set of attendees; and
providing a fourth communication associated with the third communication to the person prior to receiving the first communication from the person.

7. The method of claim 1 further comprising:
providing a third communication associated with the first communication to at least one of a third plurality of event endpoints of a third event in progress, the third plurality of event endpoints providing a third set of media streams to a third set of attendees.

8. The method of claim 7 further comprising:
receiving the first communication from an input/output device that is remotely located from each of the third plurality of event endpoints.

9. The method of claim 1 further comprising:
associating the first person with the first event using a first registered event specification corresponding to the first event.

10. The method of claim 1 further comprising:
associating a location of the first person with the scheduled event or the in progress event using event endpoint information.

11. A program product comprising:
a program executable by a processor for causing the processor to:
detect that a person associated with a scheduled event has checked in for the scheduled event, the scheduled event including a first plurality of event endpoints that provide a first set of media streams to a first set of attendees;
receive a first communication from the person that is directed to an in progress event that has a common resource with the first event; and
provide a second communication associated with the first communication to at least one of a second plurality endpoints of the in progress event, the second plurality of event endpoints providing a second set of media streams to a second set of attendees;
a medium that stores the program so that the program is accessible by the processor.

12. The program product of claim 11 wherein the program is executable by the processor for causing the processor to:
receive the first communication from one of a hallway or a vestibule that is adjacent to a room that includes a set of audio/video devices of the one of the second plurality of event endpoints.

13. The program product of claim 11 wherein the program is executable by the processor for causing the processor to:
receive the first communication from an input/output device that is remotely located from each of the second plurality of event endpoints.

14. The program product of claim 11 wherein the program is executable by the processor for causing the processor to:
receive the first communication from a first one of the first plurality of event endpoints;
wherein the common resource is a second one of the first plurality of event endpoints and one of the second plurality of event endpoints.

15. The program product of claim 11 wherein the program is executable by the processor for causing the processor to:
receive a third communication one of the second set of attendees; and
provide a fourth communication associated with the third communication to the person in response to detecting that the person has check in for the scheduled event.

16. A system comprising:
a network interface configured to connect to a network; and
an event management system coupled to the network interface, including first and second registered event specifications corresponding to an in progress event and a scheduled event, respectively, and dynamic event context information that indicates relative status of the first and the second events;
wherein the event management system is configured to receive a first communication from a person identified by the second registered event specification using the network interface, wherein the event management system is configured to identify a first plurality endpoints of the in progress event using the second registered event specification and the dynamic event context information, and wherein the event management system is configured to provide a second communication associated with the first communication to at least one of the first plurality endpoints using the network interface to cause the first plurality of event endpoints to provide the second communication to a set of attendees while providing a first set of media streams to the set of attendees.

17. The system of claim 16 further comprising:
the first plurality of event endpoints; and
a second plurality of event endpoints configured to provide a second set of media streams to a second set of attendees during the scheduled event.

18. The system of claim 16 wherein the at least two of the second plurality of event endpoints are remotely located from one another.

19. The system of claim 16 wherein the event management system is configured to process the first communication in accordance with a policy corresponding to the scheduled event.

20. The system of claim 16 wherein the event management system is configured to select the second communication in accordance with a policy corresponding to the in progress event.
